(19) United States
(12) Patent Application Publication
(10) Pub. No.: US 2021/0209263 A1
(43) Pub. Date: Jul. 8, 2021

(54) TUNNEL TUNNELING FEASIBILITY PREDICTION METHOD AND SYSTEM BASED ON TBM ROCK-MACHINE PARAMETER DYNAMIC INTERACTION MECHANISM

(71) Applicant: SHANDONG UNIVERSITY, Jinan, Shandong (CN)

(72) Inventors: Shucai LI, Jinan (CN); Yiguo XUE, Jinan (CN); Chuanqi QU, Jinan (CN); Daohong QIU, Jinan (CN); Yufan TAO, Jinan (CN); Guangkun LI, Jinan (CN); Maoxin SU, Jinan (CN); Jiuhua CUI, Jinan (CN); Peng WANG, Jinan (CN)

(73) Assignee: SHANDONG UNIVERSITY, Jinan, Shandong (CN)

(21) Appl. No.: 17/057,443

(22) PCT Filed: Jan. 17, 2020
(86) PCT No.: PCT/CN2020/072864

§ 371 Date: Nov. 20, 2020

(30) Foreign Application Priority Data
Mar. 8, 2019 (CN) 201910176393.4

(51) Int. Cl. G06F 30/13; G06F 30/20; G06F 16/21; G06N 3/00; G06F 111/06

(52) U.S. Cl. CPC G06F 30/13; G06F 30/20; G06F 2111/06; G06N 3/006; G06F 16/21

(57) ABSTRACT

A tunnel tunneling feasibility prediction method and system based on a TBM rock-machine parameter dynamic interaction mechanism includes: creating device information and rock mass information sample databases; analyzing and calculating a rock mass information sample database of a rising section of TBM tunneling parameters to obtain rock mass information weights under a condition of different device states; determining convergence conditions in different device information states through the rock-machine parameter dynamic interaction mechanism, and obtaining an optimal solution of tunneling parameters of a stable section of the TBM tunneling parameters under a condition of different rock mass information; and creating an optimal tunneling formula applicable to TBM tunneling through the obtained weight information and the optimal solution of the tunneling parameters of the stable section, performing TBM tunneling feasibility classification, and predicting TBM tunneling efficiency. Indexes of device parameters and rock parameters are selected based on TMB construction features.

### BACKGROUND

### Technical Field

The present disclosure relates to the field of tunnel engineering technologies, and in particular, to a tunnel tunneling feasibility prediction method and system based on a TBM rock-machine parameter dynamic interaction mechanism.

### Related Art

In recent years, the TBM method has become a preferred construction method for long tunnels with large section, especially mountain tunnels in China. At present, TBM construction rock mass information such as compressive strength, integrity, and other parameters is obtained through manual on-site sketching, sampling and indoor testing, and acquisition methods are relatively backward. As a result, a state of a rock mass cannot be perceived and predicted in real time.

In TBM construction, selection and control of tunneling parameters are determined and adjusted by basically completely relying on human experience, and tunneling parameters barely match rock state parameters. Once a stratum changes, or in a complex geological condition, it is difficult to effectively adjust a tunneling solution and control the parameters in time. As a result, an accident such as, jamming, a geological disaster, even a casualty or the like is likely to occur.

Therefore, intelligent TBM tunneling classification and prediction have become major technical challenges and frontier hot issues in the field of tunnel engineering.

### SUMMARY

To overcome the shortcomings in the prior art, embodiments of the present disclosure provide a tunnel tunneling feasibility prediction method based on a TBM rock-machine parameter dynamic interaction mechanism. According to the method, TBM tunneling feasibility classification is performed, and TBM tunneling efficiency is predicted based on a TBM rock-machine parameter dynamic interaction mechanism.

To achieve the foregoing objective, this application adopts the following technical solutions.

An embodiment of the present disclosure discloses a tunnel tunneling feasibility prediction method based on a TBM rock-machine parameter dynamic interaction mechanism. The method includes:

creating, according to a surrounding rock parameter-machine parameter dynamic interaction rule in a TBM tunneling process, a device information sample database and a rock mass information sample database;

analyzing and calculating a rock mass information sample database of a rising section of TBM tunneling parameters to obtain rock mass information weights under a condition of different device states;

determining convergence conditions in different device information states through the rock-machine parameter dynamic interaction mechanism, and obtaining, according to the convergence conditions, an optimal solution of tunneling parameters of a stable section of the TBM tunneling parameters under a condition of different rock mass information; and

creating an optimal tunneling formula being applicable to the TBM tunneling through the obtained weight information and the optimal solution of the tunneling parameters of the stable section, performing, according to the tunneling formula, TBM tunneling feasibility classification, and predicting TBM tunneling efficiency.

In the method of this embodiment of the present disclosure, device tunneling indexes and rock information indexes are selected based on TMB construction features, and a large amount of data is collected to form a sample database. Compared with other subjective weighting methods, the entropy weight method used in this method has higher accuracy, stronger objectivity, and obtains more accurate results. The adopted quantum-behaved particle swarm optimization avoids phenomena such as a poor global optimization capability, a slow convergence speed and the like of the conventional particle swarm optimization, and greatly improves the global optimization capability and optimization efficiency of the particle swarm optimization. In the present invention, the quantum-behaved particle swarm optimization is further improved, to avoid partial optimization at a later stage of calculation, greatly increases population diversity, and obtains results having higher quality and accuracy. Therefore, this method has quite abundant evaluation information, high efficiency, and results having high accuracy.

Another embodiment of the present disclosure discloses a tunnel tunneling feasibility prediction system based on a TBM rock-machine parameter dynamic interaction mechanism, including:

a database creating unit, configured to: create, according to a surrounding rock parameter-machine parameter dynamic interaction rule in a TBM tunneling process, a device information sample database and a rock mass information sample database;

a rock mass information weight calculation unit, configured to: analyze and calculate a rock mass information sample database of a rising section of TBM tunneling parameters to obtain rock mass information weights under a condition of different device states;

an optimal solution calculation unit, configured to: determine convergence conditions in different device information states through the rock-machine parameter dynamic interaction mechanism, and obtain, according to the convergence conditions, an optimal solution of tunneling parameters of a stable section of the TBM tunneling parameters under a condition of different rock mass information; and

a prediction unit, configured to: create an optimal tunneling formula applicable to TBM tunneling through the obtained weight information and the optimal solution of the tunneling parameters of the stable section, perform, according to the tunneling formula, TBM tunneling feasibility classification, and predict TBM tunneling efficiency.

Compared with the prior art, the present disclosure has the following beneficial effects.

1. In this method of the present disclosure, indexes of device parameters and rock parameters are selected based on TMB construction features, actual construction requirements are closely met, a large amount of sample data is selected from actual construction, and the entropy weight method is selected as a method for determining index weights. Compared with other subjective weighting methods, the entropy weight method has higher accuracy, stronger objectivity, and obtains more accurate results.

2. The improved quantum-behaved particle swarm optimization adopted in the method of the present disclosure not only greatly improves the global optimization capability and optimization efficiency of the particle swarm optimization, but also avoids a partial optimization at a later stage of calculation, greatly increases population diversity, and obtains results having higher quality and accuracy.

### BRIEF DESCRIPTION OF THE DRAWINGS

The accompanying drawings constituting a part of the present disclosure are used for providing further understanding for the present disclosure. Exemplary embodiments of the present disclosure and descriptions thereof are used for explaining the present disclosure and do not constitute an improper limitation to the present disclosure.

FIG. 1 is a flowchart of evaluation steps according to a specific embodiment of the present disclosure.

### DETAILED DESCRIPTION

It should be noted that the following detailed descriptions are all exemplary and are intended to provide a further description of the present disclosure. Unless otherwise specified, all technical and scientific terms used herein have the same meaning as commonly understood by those of ordinary skill in the art to which the present disclosure belongs.

It should be noted that terms used herein are only for describing specific implementations and are not intended to limit exemplary implementations according to the present disclosure. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

In TBM construction, selection and control of tunneling parameters are determined and adjusted by basically completely relying on human experience, and tunneling parameters barely match rock state parameters. Once a stratum changes, or in a complex geological condition, it is difficult to effectively adjust a tunneling solution and control the parameters in time. As a result, an accident such as, jamming, a geological disaster, even a casualty or the like is likely to occur. Therefore, intelligent TBM tunneling classification and prediction have become major technical challenges and frontier hot issues in the field of tunnel engineering.

### Embodiment 1

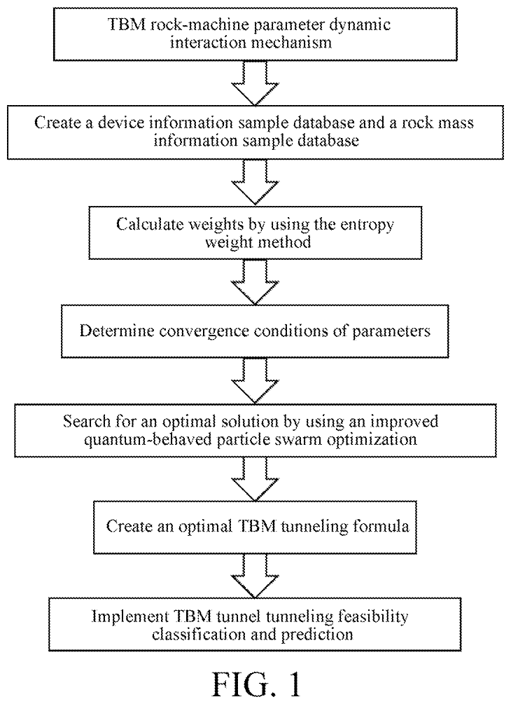

In a typical implementation of the present disclosure, referring to FIG. 1, a method applicable to intelligent TBM tunneling classification and prediction is provided. In the present disclosure, a comprehensive evaluation index system that is of TBM tunneling efficiency and that considers TBM machine parameters and surrounding rock index parameters is created by studying the TBM rock-machine parameter dynamic interaction mechanism, to obtain a machine parameter decision criterion with optimal tunneling efficiency as a decision objective.

The index evaluation index system includes TBM device parameters and rock mass index parameters. The device parameters mainly include a cutting wheel propulsive force (F), a cutting wheel torque (T), a penetration (P), and an advancing speed (R), and rock mass parameter information includes an uniaxial compressive strength of a rock mass, rock mass integrity, rock hardness, rock wear resistance, rock quartz content, a fault fracture zone, an in-situ stress state, a special rock-soil combination, groundwater, an angle θ between the direction of a dominant structural plane of the rock mass and a tunnel line.

After the evaluation index system is created, the comprehensive evaluation of TBM tunneling efficiency may be performed, to obtain an optimal tunneling solution of a TBM in a rock stratum and a tunneling feasibility prediction.

In this embodiment, existing TBM tunneling rock machine information is collected and summarized, a sample database is created, and a tunneling cycle in a normal TBM tunneling process is analyzed to obtain TBM tunneling parameters including a rising section of the TBM tunneling parameters and a stable section of the TBM tunneling parameters; a rock mass information sample database is analyzed and calculated by using the entropy weight method for the rising section of the TBM tunneling parameters, to obtain rock mass information weights under a condition of different device states; convergence conditions in different device information states are determined through the rock-machine parameter dynamic interaction mechanism, and an optimal solution of the stable section of the TBM tunneling parameters is obtained according to the convergence conditions by using the improved quantum-behaved particle swarm optimization under a condition of different rock mass information; and an optimal tunneling formula applicable to the TBM tunneling is created through the obtained weight information and the optimal solution of the tunneling parameters of the stable section.

In the method, device tunneling indexes and rock information indexes are selected based on TMB construction features, and a large amount of data is collected to form a sample database. Compared with other subjective weighting methods, the entropy weight method used in this method has higher accuracy, stronger objectivity, and obtains more accurate results. The adopted quantum-behaved particle swarm optimization avoids phenomena such as a poor global optimization capability, a slow convergence speed and the like of the conventional particle swarm optimization, and greatly improves the global optimization capability and optimization efficiency of the particle swarm optimization. In the present invention, the quantum-behaved particle swarm optimization is further improved, to avoid partial optimization at a later stage of calculation, greatly increases population diversity, and obtains results having higher quality and accuracy. Therefore, this method has quite abundant evaluation information, high efficiency, and results having high accuracy.

The following describes the TBM rock-machine dynamic interaction mechanism, that is, a surrounding rock parameter-machine parameter dynamic interaction rule in a TBM tunneling process, and a tunnel surrounding rock parameter-TBM machine parameter feedback model is created according to the rule.

In a specific embodiment, TBM tunneling processes of different stratums, different rocks, and different machine parameters are simulated, to obtain a correlation between the surrounding rock parameters and the machine parameters in the TBM tunneling process, and obtain a correlation between machine parameters, such as an output torque, a rotation speed, a tunneling speed, and a propulsive force in the TBM tunneling process and surrounding rock parameters such as an uniaxial compressive strength of a rock, a tensile strength of the rock, rock hardness, a structural plane spacing, and an angle between a tunnel axis and a main structural plane.

A TBM automatically records various machine parameters and surrounding rock parameters in a tunneling process. The correlation between the TBM machine parameters (such as the torque, the rotation speed, the tunneling speed, and the propulsive force) and the surrounding rock parameters (such as the uniaxial compressive strength of the rock, the tensile strength of the rock, the rock hardness, the structural plane spacing, and the angle between the tunnel axis and the main structural plane) is obtained, a TBM surrounding rock parameter-machine parameter tunneling model is created, TBM tunneling speeds under different combinations of TBM operating conditions and the surrounding rock parameters are calculated, and the correlation between the TBM machine parameters and surrounding rock parameters is analyzed, where the TBM operating conditions include different TBM output torques and propulsive forces, and surrounding rock parameter conditions include different combinations of a compressive strength, a tensile strength, an elastic model, a joint spacing, an inclination angle and in-situ stress.

A tunnel surrounding rock parameter-TBM machine parameter feedback model is created by using the obtained rock-machine parameter dynamic interaction mechanism, to determine convergence conditions in different device information states.

In a TBM tunneling cycle, starting from a hob contacting a rock, TBM tunneling parameters such as a penetration, a propulsive force, and a torque gradually increase to stable values. This phase is referred to as the rising section of the TBM tunneling parameters; a phase in which the TBM tunneling parameters remain stable and slightly fluctuate is referred to as the stable section of the TBM tunneling parameters.

In this embodiment, the mechanism reflects a TBM rock-machine dynamic interaction rule, which is a basis to create a comprehensive evaluation index system of TBM tunneling efficiency and obtain a machine parameter decision criterion with optimal tunneling efficiency as a decision objective.

The evaluation index system is created based on the TBM rock-machine parameter dynamic interaction mechanism by using a comprehensive evaluation method. The comprehensive evaluation method adopted in this embodiment of the present disclosure includes the entropy weight method and the quantum particle swarm optimization.

In a specific embodiment, weights of different rock mass parameters are calculated by using the entropy weight method. The calculation process is a conventional calculation process of the entropy weight method.

In a specific embodiment, the device parameters mainly include a cutting wheel propulsive force (F), a cutting wheel torque (T), a penetration (P), and an advancing speed (R), and rock mass parameter information includes an uniaxial compressive strength of a rock mass, rock mass integrity, rock hardness, rock wear resistance, rock quartz content, a fault fracture zone, an in-situ stress state, a special rock-soil combination, groundwater, and an angle θ between the direction of a dominant structural plane of the rock mass and a tunnel line.

The rock integrity is measured by using RQD values, the rock hardness is measured by using a breaking specific power z, the rock wear resistance is measured by using a rock wear resistance index CAI, an impact degree of the fault fracture zone is reflected by using a width w, the in-situ stress state is measured by using a stress index d, the special rock-soil combination includes two conditions: a granite alteration zone and upper and lower rocks having different softness and hardness, and an impact degree thereof is measured by using a hardness difference σ between the two rocks, and groundwater is indicated by using a water influx q per unit.

A TBM tunneling cycle device information sample database and a rock mass information sample database are created, and a rock mass information sample database of a rising section of TBM tunneling parameters is analyzed and calculated by using the entropy weight method, to obtain rock mass information weights under a condition of different device states.

The TBM tunneling cycle includes the rising section of parameters and the stable section of parameters. Weights of different rock mass information of the rising section of the parameters are calculated by using the entropy weight method. An optimal tunneling solution of the stable section of the TBM parameters is obtained through a rock-machine responding rule of the rising section of the TBM parameters in combination with the TBM rock-machine interaction mechanism.

The entropy weight method is a method for assigning weights to indexes, and an entropy can represent an amount of effective information displayed in the data. If an index value of a to-be-evaluated thing slightly changes, an entropy value is relatively high, indicating that an amount of effective information given by the index is relatively small, and an occupied weight is relatively low; otherwise, the result is opposite. An advantage of the entropy weight method is that the entropy weight method is an objective weight assigning method, to greatly alleviate an impact of a human factor on an index weight. For the weight assigning problem of a plurality of evaluation objects, index weights applicable to the evaluation objects can be obtained only by performing calculation once by using the entropy weight method, to greatly simplify the calculation process. Weights are assigned to the evaluation indexes by using the entropy weight method, to link the plurality of evaluation objects, to reduce an impact of an accidental situation, so that an evaluation result is more proper.

Specific calculation steps are as follows: (1) raw data is normalized. A matrix of the raw data is constructed according to the obtained data, and then dimensionless operation is performed on the matrix of the raw data. (2) An information entropy is calculated. (3) An entropy weight is calculated, and a weight of a corresponding index may be calculated according to the obtained information entropy.

The surrounding rock parameter-machine parameter dynamic interaction rule in the TBM tunneling process is studied according to obtained relevant TBM data. The tunnel surrounding rock parameter-TBM machine parameter feedback model is created. The optimal TBM tunneling speed may be learned of according to the obtained feedback model under some surrounding rock conditions.

Convergence conditions in different device information states are determined through the rock-machine parameter dynamic interaction mechanism, and an optimal solution of the tunneling parameters of the stable section of the TBM tunneling parameters under a condition of different rock mass information is obtained by using the improved quantum-behaved particle swarm optimization according to the convergence conditions.

The quantum-behaved particle swarm optimization is a global optimization algorithm. That is, after different rock mass information is mastered, the optimal TBM tunneling speed under this rock mass information operating condition can be obtained through the TBM rock-machine interaction mechanism and weights obtained by using the entropy weight method.

A cumbersome decoding method brought by direct use of binary encoding is avoid by using a probability as an encoding method of the quantum-behaved particle swarm optimization. In quantum calculation, two basic states of microscopic particles are represented by using |0> and |1> that are referred to as qubits. The symbol “|>” is a Dirac symbol. In the quantum-behaved particle swarm optimization (QPSO), a smallest unit is a qubit. The qubit has two basic states: the |0> state and the |1> state. The state of the qubit at any time may be a linear combination of basic states, and is referred to as a superposition state.

In this embodiment of the present disclosure, the quantum-behaved particle swarm optimization is improved in three aspects: a chaos search, an optimal position center of a weighted update population and a neighborhood mutation, and a population is initialized by using a chaotic thought, so that initial population diversity and distribution balance may be effectively improved, and an algorithm convergence speed and search precision may be increased; a population evolution method is improved by using the optimal position center of the weighted update population, so that interference of lagging particles may be effectively reduced, guiding roles of elite individuals in the population evolution may be enhanced, and population search capability may be improved to accelerate the convergence; and a local refined search is performed on random mutation of an optimal individual of the population within a neighborhood range shrinking generation by generation; if fitness of a new individual obtained through the mutation has been improved, a global optimal individual of the population before mutation is directly replaced, and otherwise the individuals in the population are randomly replaced at a probability.

An optimal tunneling formula applicable to the TBM tunneling is created through the obtained weight information and the optimal solution of the tunneling parameters of the stable section. TBM tunneling feasibility classification is performed according to the tunneling formula, and TBM tunneling efficiency is predicted based on a TBM rock-machine parameter dynamic interaction mechanism.

Specifically, the optimal tunneling formula is mainly used to have an overall grasp of a problem of tunneling feasibility under an operating condition to overall score; and is subsequently used to perform tunneling feasibility classification, that is, perform tunneling feasibility classification according to different surrounding rock parameters of different areas, so that an optimal construction method and a supporting structure design are given according to the tunneling feasibility classification. The optimal tunneling formula is a basis of performing scientific management, correctly evaluating economic benefits, making labor quotas and material consumption standards and the like, and has great significance.

The optimal TBM tunneling formula is created. The formula is E=Cᵢ^{F}+Cⱼ^{T}+Cₖ^{P}+Cₘ^{R}, where E is an optimal total TBM tunneling score, classification is performed, according to engineering practice and expert experience, on scores, and TBM tunnel tunneling feasibility classification is determined. Cᵢ^{F}, Cⱼ^{T}, Cₖ^{P}, Cₘ^{R} are scores of device parameters including a cutting wheel propulsive force (F), a cutting wheel torque (T), a penetration (P), and an advancing speed ®. Score formulas of the device parameters are as follows:

$$\{ \begin{matrix}{C}_{i}^{F} = {\sum }_{i}^{n} {w}_{i} {e}_{i} \\ {C}_{i}^{T} = {\sum }_{j}^{n} {w}_{j} {e}_{j} \\ {C}_{k}^{P} = {\sum }_{k}^{n} {w}_{k} {e}_{k} \\ {C}_{m}^{R} = {\sum }_{m}^{n} {w}_{m} {e}_{m}\end{matrix}$$

where wᵢ, wⱼ, wₖ, wₘ are weights that are of rock mass parameters and that are obtained by using an entropy weight method under a condition of different device parameters, eᵢ, eⱼ, eₖ, eₘ are scores that are of the rock mass parameters and that are obtained according to a rock-machine interaction relationship under the condition of the different device parameters, and n is a quantity of rock mass parameters.

In this embodiment of the present disclosure, TBM tunneling parameters are obtained by using the TBM rock-machine parameter dynamic interaction mechanism as a theoretical basis, and parameters of a TBM machine that passes through a typical unfavorable-geology section (a fault, lithological mutation, a water-rich rock mass, or the like) based on a project are collected and sorted. The TBM machine parameters include data before, when, and after the TMB passes through the unfavorable-geology section, and a change rule of the TBM machine parameters of passing through the unfavorable geology is studied. A TBM machine parameter characterization method for an unfavorable-geology tunnel with optimal tunneling efficiency as a standard is created, discrimination index systems of different unfavorable geologies are created by using the entropy weight method and the quantum-behaved particle swarm optimization, change rules and features of unfavorable-geology discrimination indexes when a TBM passes through an unfavorable-geology section are analyzed, an advance identification criterion when a TMB is close to an unfavorable geology is created, and real-time advance identification and warning of an unfavorable geology in the TBM tunneling process are implemented.

### Embodiment 2

This embodiment discloses a tunnel tunneling feasibility prediction system based on a TBM rock-machine parameter dynamic interaction mechanism, including:

a database creating unit, configured to: create, according to a surrounding rock parameter-machine parameter dynamic interaction rule in a TBM tunneling process, a device information sample database and a rock mass information sample database;

a rock mass information weight calculation unit, configured to: analyze and calculate a rock mass information sample database of a rising section of TBM tunneling parameters to obtain rock mass information weights under a condition of different device states;

an optimal solution calculation unit, configured to: determine convergence conditions in different device information states through the rock-machine parameter dynamic interaction mechanism, and obtain, according to the convergence conditions, an optimal solution of tunneling parameters of a stable section of the TBM tunneling parameters under a condition of different rock mass information; and

a prediction unit, configured to: create an optimal tunneling formula applicable to TBM tunneling through the obtained weight information and the optimal solution of the tunneling parameters of the stable section, perform, according to the tunneling formula, TBM tunneling feasibility classification, and predict TBM tunneling efficiency.

It should be noted that although a plurality of modules or sub-modules of a device are mentioned in the foregoing detailed description, but such division is merely exemplary, not mandatory. Actually, according to the embodiments of the present disclosure, the features and functions of two or more modules described above may be embodied in one module. Conversely, the features or functions of one module described above may be further divided and embodied by a plurality of modules.

### Embodiment 3

This embodiment discloses a computer device, including a memory, a processor, and a computer program stored on the memory and capable of running on the processor, where when the processor executes the program, steps of the tunnel tunneling feasibility prediction method based on a TBM rock-machine parameter dynamic interaction mechanism are implemented.

### Embodiment 4

This embodiment discloses a computer-readable storage medium, storing a computer program, where when the program is executed by a processor, steps of the tunnel tunneling feasibility prediction method based on a TBM rock-machine parameter dynamic interaction mechanism are implemented.

In this embodiment, a computer program product may include a computer-readable storage medium, storing computer-readable program instructions used for performing the aspects of the present disclosure. The computer-readable storage medium may be a physical device that can retain and store an instruction used by an instruction-executing device. The computer-readable storage medium may be, for example, but is not limited to, an electrical storage device, a magnetic storage device, an optical storage device, an electromagnetic storage device, a semiconductor storage device, or any appropriate combination of the above.

The foregoing descriptions are merely preferred embodiments of the present disclosure, but are not intended to limit the present disclosure. The present disclosure may include various modifications and changes for a person skilled in the art. Any modification, equivalent replacement, or improvement made within the spirit and principle of the present disclosure shall fall within the protection scope of the present disclosure.

1. A tunnel tunneling feasibility prediction method based on a TBM rock-machine parameter dynamic interaction mechanism, comprising:
creating, according to a surrounding rock parameter-machine parameter dynamic interaction rule in a TBM tunneling process, a device information sample database and a rock mass information sample database;
analyzing and calculating a rock mass information sample database of a rising section of TBM tunneling parameters to obtain rock mass information weights under a condition of different device states;
determining convergence conditions in different device information states through the rock-machine parameter dynamic interaction mechanism, and obtaining, according to the convergence conditions, an optimal solution of tunneling parameters of a stable section of the TBM tunneling parameters under a condition of different rock mass information; and
creating an optimal tunneling formula applicable to TBM tunneling through the obtained weight information and the optimal solution of the tunneling parameters of the stable section, performing, according to the tunneling formula, TBM tunneling feasibility classification, and predicting TBM tunneling efficiency.

2. The tunnel tunneling feasibility prediction method based on a TBM rock-machine parameter dynamic interaction mechanism according to claim 1, wherein an optimal total TBM tunneling score is calculated according to the optimal tunneling formula applicable to the TBM tunneling, classification is performed on scores according to engineering practice and expert experience, and TBM tunnel tunneling feasibility classification is determined;
the optimal total TBM tunneling score is specifically:
E=Cᵢ^{F}+Cⱼ^{T}+Cₖ^{P}+Cₘ^{R}, wherein E is the optimal total TBM tunneling score, and Cᵢ^{F}, Cⱼ^{T}, Cₖ^{P}, Cₘ^{R} are scores of device parameters comprising a cutting wheel propulsive force F, a cutting wheel torque T, a penetration P, and an advancing speed R.

3. The tunnel tunneling feasibility prediction method based on a TBM rock-machine parameter dynamic interaction mechanism according to claim 2, wherein score formulas of the device parameters are as follows:
$$\{ \begin{matrix}{C}_{i}^{F} = {\sum }_{i}^{n} {w}_{i} {e}_{i} \\ {C}_{i}^{T} = {\sum }_{j}^{n} {w}_{j} {e}_{j} \\ {C}_{k}^{P} = {\sum }_{k}^{n} {w}_{k} {e}_{k} \\ {C}_{m}^{R} = {\sum }_{m}^{n} {w}_{m} {e}_{m}\end{matrix}$$
wherein wᵢ, wⱼ, wₖ, wₘ are weights that are of rock mass parameters and that are obtained by using an entropy weight method under a condition of different device parameters, eᵢ, eⱼ, eₖ, eₘ are scores that are of the rock mass parameters and that are obtained according to a rock-machine interaction relationship under the condition of the different device parameters, and n is a quantity of the rock mass parameters.

4. The tunnel tunneling feasibility prediction method based on a TBM rock-machine parameter dynamic interaction mechanism according to claim 1, wherein the TBM rock-machine parameter dynamic interaction mechanism is a correlation between machine parameters such as an output torque, a rotation speed, a tunneling speed, and a propulsive force in the TBM tunneling process and surrounding rock parameters such as an uniaxial compressive strength of a rock, a tensile strength of the rock, rock hardness, a structural plane spacing, and an angle between a tunnel axis and a main structural plane.

5. The tunnel tunneling feasibility prediction method based on a TBM rock-machine parameter dynamic interaction mechanism according to claim 2, wherein the rock mass information sample database of the rising section of the TBM tunneling parameters is analyzed and calculated to obtain rock mass information weights under the condition of the different device states, and the rock mass information weights are obtained by using an entropy weight method.

6. The tunnel tunneling feasibility prediction method based on a TBM rock-machine parameter dynamic interaction mechanism according to claim 2, wherein the convergence conditions in the different device information states are determined through the rock-machine parameters dynamic interaction mechanism, and the optimal solution of the tunneling parameters of the stable section of the TBM tunneling parameters under the condition of the different rock mass information is obtained according to the convergence conditions by using an improved quantum-behaved particle swarm optimization.

7. The tunnel tunneling feasibility prediction method based on a TBM rock-machine parameter dynamic interaction mechanism according to claim 6, wherein the quantum-behaved particle swarm optimization is improved in three aspects: a chaos search, an optimal position center of a weighted update population and a neighborhood mutation, and a population is initialized by using a chaotic thought; a population evolution method is improved by using the optimal position center of the weighted update population; and a local refined search is performed on random mutation of an optimal individual of the population within a neighborhood range shrinking generation by generation; in a case that fitness of a new individual obtained through the mutation has been improved, a global optimal individual of the population before mutation is directly replaced, and otherwise individuals in the population are randomly replaced at a probability.

8. A tunnel tunneling feasibility prediction system based on a TBM rock-machine parameter dynamic interaction mechanism, comprising:
a database creating unit, configured to: create, according to a surrounding rock parameter-machine parameter dynamic interaction rule in a TBM tunneling process, a device information sample database and a rock mass information sample database;
a rock mass information weight calculation unit, configured to: analyze and calculate a rock mass information sample database of a rising section of TBM tunneling parameters to obtain rock mass information weights under a condition of different device states;
an optimal solution calculation unit, configured to: determine convergence conditions in different device information states through the rock-machine parameter dynamic interaction mechanism, and obtain, according to the convergence conditions, an optimal solution of tunneling parameters of a stable section of the TBM tunneling parameters under a condition of different rock mass information; and
a prediction unit, configured to: create an optimal tunneling formula applicable to TBM tunneling through the obtained weight information and the optimal solution of the tunneling parameters of the stable section, perform, according to the tunneling formula, TBM tunneling feasibility classification, and predict TBM tunneling efficiency.

9. A computer device, comprising a memory, a processor, and a computer program stored in the memory and capable of running on the processor, wherein when the processor executes the program, the steps of the tunnel tunneling feasibility prediction method based on a TBM rock-machine parameter dynamic interaction mechanism according to claim 1 are implemented.

10. A computer-readable storage medium, storing a computer program, wherein when the program is executed by a processor, the steps of the tunnel tunneling feasibility prediction method based on a TBM rock-machine parameter dynamic interaction mechanism according to claim 1 are implemented.
